(19) United States
(12) Patent Application Publication
(10) Pub. No.: US 2026/0105682 A1
(43) Pub. Date: Apr. 16, 2026

(54) UTILIZATION OF VIRTUAL VIDEO CAMERAS FOR IMAGE CAPTURING IN A VIRTUAL WORLD COLLABORATION ENVIRONMENT

(71) Applicant: INTERNATIONAL BUSINESS MACHINES CORPORATION, ARMONK, NY (US)

(72) Inventors: Ya Qing Chen, Shanghai (CN); Liang Ying Xu, Beijing (CN); Jian Wang, Shanghai (CN); Chuan Le Zheng, Shanghai (CN); Xiao Feng Ji, Shanghai (CN)

(21) Appl. No.: 18/914,357

(22) Filed: Oct. 14, 2024

(51) Int. Cl. G06T 17/00; G06F 3/01; G06V 10/762

(52) U.S. Cl. CPC G06T 17/00; G06F 3/013; G06V 10/762

(57) ABSTRACT

In an approach to improve computer-based virtual world collaboration environments, embodiments project a three-dimensional vector of a user in a three-dimensional (3D) virtual world environment to one or more invisible two-dimensional (2D) unit vectors on a virtual horizontal ground and translate the one or more unit vectors into a circle centered geometrically at positions related to the user. Further, embodiments identify a first semicircle of the circle and place a first virtual video camera on a radius perpendicular to a diameter of the first semicircle that passes through the center of the circle. Additionally, embodiments identify an image capturing duration and image capturing sequence based on a total number of line-of-sight attentions received by the user and adjust a distance between the first virtual video camera and the center of the circle dynamically, according to the total number of line-of-sight attentions received by user.

### BACKGROUND OF THE INVENTION

The present invention relates generally to virtual world environments, and more particularly to the field of computer-based virtual world collaboration.

A virtual world/virtual world environment (e.g., the metaverse) is an evolving collection of technologies that immerse users in a real-time social network of commerce-connected 3D spaces. A virtual world environment is a computer-simulated environment which may be populated by many users who can create a personal avatar, and simultaneously and independently explore the virtual world, participate in its activities, and communicate with others. That can include virtual reality (VR)—characterized by persistent virtual worlds that continue to exist even when you're not there—as well as augmented reality (AR), which combines aspects of digital worlds and physical worlds. Access points for a virtual world environment includes general-purpose computers and smartphones, augmented reality, mixed reality, and virtual reality. Video recording and streaming of virtual world environments has become popular among users. The video capturing can be two-dimensional (2D) or 3D. A three-dimensional (3D) image consists of two spherical images taken from two different positions that are about as far from each other as the typical distance between two eyes.

### SUMMARY

Embodiments disclose a computer-implemented method, a computer program product, and a system, for improving computer-based virtual world image capturing, the computer-implemented method comprising: projecting a three-dimensional vector of one or more users in a three-dimensional (3D) virtual world environment to one or more invisible two-dimensional (2D) unit vector on a virtual horizontal ground; translating the one or more unit vectors into a circle centered geometrically at positions related to the one or more users, wherein a starting point of each of the one or more unit vector coincides with a center of the circle; identifying a first semicircle of the circle; placing a first virtual video camera on a radius perpendicular to a diameter of the first semicircle that passes through the center of the circle; identifying an image capturing duration and image capturing sequence based on a total number of line-of-sight attentions received by the one or more users; and adjusting a distance between the first virtual video camera and the center of the circle dynamically, according to the total number of line-of-sight attentions received by the one or more users.

Embodiments further disclose dividing the one or more users within the 3D virtual world environment into groups, wherein dividing the one or more users within the 3D virtual world environment into groups comprises: clustering the one or more users into one or more groups based on positions of a virtual avatar associated with each user in the virtual world environment. Embodiments further disclose wherein identifying the first semicircle comprises: identifying a first semicircle based on an amount of unit vectors present in the first semicircle, wherein the first semicircle comprises at least one or more unit vector than the second semicircle. Embodiments further disclose identifying the image capture duration comprises allocating the image capture duration of the one or more users in a group proportionally, wherein an image capturing-duration ratio corresponds to a ratio of a total number of line-of-sight attentions received by a user in the group. Embodiments further disclose capturing images of a group with the first virtual video camera and a second virtual camera in a determined sequence, wherein the first virtual video camera and the second virtual camera capture images of a plurality of groups in a descending order, according to the total number of line-of-sight attentions received by users in plurality of groups. Embodiments further disclose identifying a primary virtual video camera, wherein identifying the primary virtual video camera comprises: monitoring line-of-sight attention being received by each user in a group; and responsive to identifying a virtual video camera filming the one or more users receiving a majority of the line-of-sight attention based on the monitoring, labeling the virtual video camera as the primary virtual video camera.

### BRIEF DESCRIPTION OF THE DRAWINGS

FIG. 1 is a functional block diagram illustrating a distributed data processing environment, executing a virtual world image capturing program, in accordance with an embodiment of the present invention;

FIG. 2 illustrates a functional block diagram and operational steps of the virtual world image capturing program, on a server computer within the distributed data processing environment of FIG. 1, in accordance with an embodiment of the present invention;

FIG. 3 is a functional block diagram illustrating a distributed data processing environment in accordance with an embodiment of the present invention;

FIG. 4 is a functional block diagram illustrating a distributed data processing environment in accordance with an embodiment of the present invention; and

FIG. 5 illustrates operational steps of the virtual world image capturing program, on a server computer within the distributed data processing environment of FIG. 1, in accordance with an embodiment of the present invention.

### DETAILED DESCRIPTION

Embodiments recognize that with the further development and application of virtual world environments, more and more conferences will be organized by category and/or predetermined features (e.g., schools, companies, governments or institutions etc.) in virtual 3D scenarios. Embodiments recognize that, with 3D virtual conference, users expect the conference content to be shared on the Internet or otherwise in the form of one or more recorded videos that is accessible by a user to view or review at a later time (e.g., watch the video at any time to experience the conference's dynamics as if they were in the conference in person).

Further, embodiments recognize that although multi-view video and 360-degree video techniques can provide recorded videos of conferences, they also have comprised several disadvantages. For example, (1) The multi-view video technique uses multiple video cameras in fixed positions to shoot, so some speakers' faces may not be captured all the time, (2) 360-degree videos rely heavily on virtual reality (VR) devices for most of the time and those that are viewed on other devices, such as PCs, smartphones or tablets, fail to provide a(n) ideal and/or coherent user experience, and (3) Multi-view videos and 360-degree videos allow viewers to manually select one of different viewing angles to watch. Viewers may constantly change view angles in order to follow the real-time change of the face orientation of speakers, which disrupts the viewers' immersive viewing experience. Moreover, for viewers with decidophobia, the abundance of viewing angles makes it difficult for them to choose a better viewing angle, even causing them anxiety or stress.

Additionally, embodiments recognize that for large-scale events in the physical world such as important conferences, sports events and concerts, live on-site video recording can be used to broadcast or record 2D videos in real time. Such videos can be transmitted to the Internet for viewers to watch on their PCs, smartphones or tablets. Embodiments recognize that live on-site image capturing needs to artificially determine the image capturing positions and angles of one or more image capturing devices in real time according to the dynamics (e.g., a speaker starts to speak) of events, and artificially switch among the respective captured video frames of multiple image capturing devices. Live on-site image capturing can provide viewers with a best single viewing angle in real time, so that viewers can have an immersive viewing experience without manually choosing one viewing angle themselves. Image capturing is any form, method, and/or combination of form and method of image capturing known and understood in the art (e.g., video capturing through the use of image/video capturing devices). However, tracking and image capturing an event that is happening in a 3D virtual environment by one or more human photographers (holding a virtual video camera by their respective virtual avatars) in real time, is inefficient, costly and difficult to guarantee the quality of recorded video contents. Good cooperation and collaboration between those human photographers are also required (traditionally a role like photography director is involved), thus, creating a need for an efficient deployment and control method of virtual video cameras in real time for live on-site image capturing in a 3D virtual environment.

Embodiments improve the art and solve at least the issues stated above by deploying virtual video cameras in a 3D virtual environment for live on-site image capturing. More specifically, embodiments improve the art and solve at least the issues stated above by (i) projecting head orientation (a three-dimensional vector) of each speaker in the 3D virtual environment to an invisible two-dimensional unit vector on the virtual horizontal ground; (ii) translating unit vectors into an invisible circle centered geometrically at the positions of related speakers, wherein the starting point of each unit vector coincides with the center of the circle; (iii) determining the circle, one semicircle containing most unit vectors as a first semicircle; (iv) placing a first virtual video camera on a radius (as the movement track) perpendicular to the diameter of the first semicircle and passes through the center of the circle; (v) determining the image capturing duration and image capturing sequence for the first virtual video camera, based on the total number of line-of-sight attentions received by the speakers whose faces are to be filmed by the first virtual video camera; and (vi) adjusting the distance between the first virtual video camera and the center of the circle dynamically, according to the decrement or increment of the total number of line-of-sight attentions received by the speakers who are being filmed by the first virtual video camera.

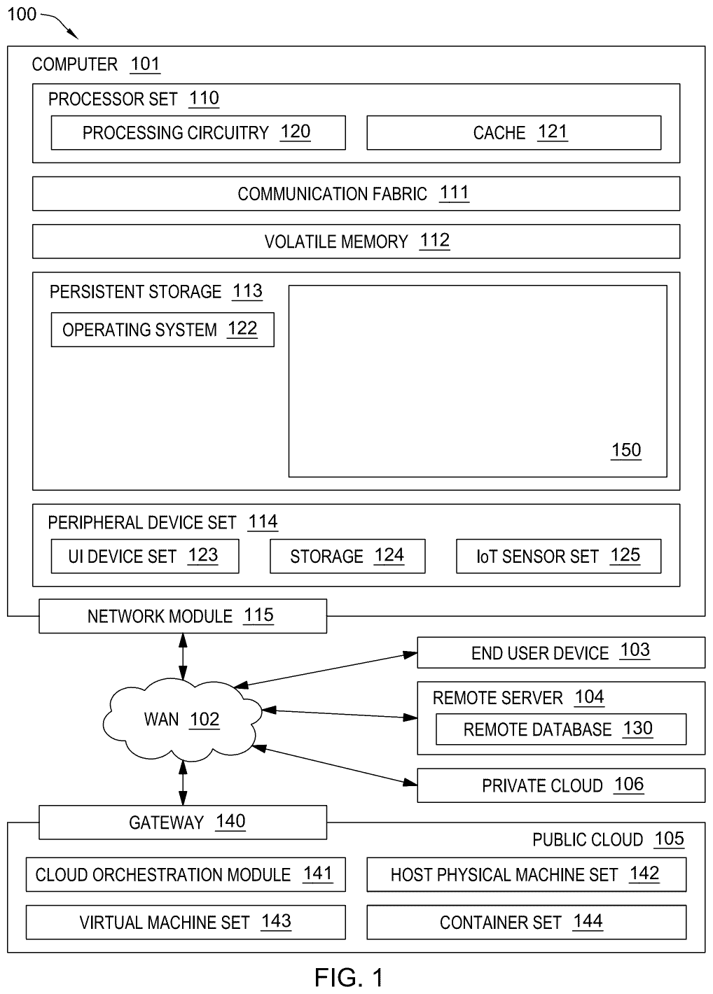

Implementation of embodiments of the invention may take a variety of forms, and exemplary implementation details are discussed subsequently with reference to the Figures (i.e., FIG. 1-FIG. 5).

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails, and texts, and/or responsive display prompts begin with a written notification that the user's information may be recorded or monitored and may be saved, for the purpose of consolidating shipments to reduce carbon emissions and shipping costs. These embodiments may also include periodic reminders of such recording and monitoring throughout the course of any such use. Certain embodiments may also include regular (e.g., daily, weekly, monthly) reminders to the participating parties that they have consented to being recorded and monitored for collision avoidance and autonomous vehicle safety measures and may provide the participating parties with the opportunity to opt-out of such recording and monitoring if desired.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as virtual world image capturing program (component) 150. In addition to component 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and component 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in component 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in component 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. IoT sensor set 125 may be any combination of proximity sensors, image sensor, motion sensor, thermistor, capacity sensing, photoelectric sensor, infrared sensor, level sensor, humidity sensor, pressure sensor, temperature sensor, and/or any sensor and/or IoT sensor known and understood in the art.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In various embodiments, component 150 automatically deploys virtual video capturing devices in a 3D virtual environment for live on-site image capturing. In various embodiments, component 150 improves and solves at least the issues stated above by (i) projecting head orientation (a three-dimensional vector) of each user(s) in the 3D virtual environment to an invisible two-dimensional unit vector on the virtual horizontal ground; (ii) translating unit vectors into an invisible circle centered geometrically at the positions of related user(s), wherein the starting point of each unit vector coincides with the center of the circle; (iii) determining the circle, one semicircle containing most unit vectors as a first semicircle; (iv) placing a first virtual video camera on a radius (as the movement track) perpendicular to the diameter of the first semicircle and passes through the center of the circle; (v) determining the image capturing duration and image capturing sequence for the first virtual video camera, based on the total number of line-of-sight attentions received by the speakers whose faces are to be filmed by the first image capturing device (e.g., virtual camera or video camera); and (vi) adjusting the distance between the first image capturing device and the center of the circle dynamically, according to the decrement or increment of the total number of line-of-sight attentions received by the speakers who are being filmed by the first image capturing device.

In various embodiments, component 150 projects a three-dimensional vector of one or more users in a three-dimensional (3D) virtual world environment to one or more invisible two-dimensional (2D) unit vector on a virtual horizontal ground, and translate the one or more unit vectors into a circle centered geometrically at positions related to the one or more users, wherein a starting point of each of the one or more unit vector coincides with a center of the circle. In various embodiments, component 150 identifies a first semicircle of the circle, places a first virtual video camera on a radius perpendicular to a diameter of the first semicircle that passes through the center of the circle, and identifies an image capturing duration and image capturing sequence based on a total number of line-of-sight attentions received by the one or more users. In various embodiments, component 150 adjusts a distance between the first virtual video camera and the center of the circle dynamically, according to the total number of line-of-sight attentions received by the one or more users. In various embodiments, component 150 divides the one or more users within the 3D virtual world environment into groups, wherein dividing the one or more users within the 3D virtual world environment into groups comprises: clustering the one or more users into one or more groups based on positions of a virtual avatar associated with each user in the virtual world environment.

In various embodiments, identifying the first semicircle comprises: identifying a first semicircle based on an amount of unit vectors present in the first semicircle, wherein the first semicircle comprises at least one or more unit vector than the second semicircle. In various embodiments, identifying the image capture duration comprises allocating the image capture duration of the one or more users in a group proportionally, wherein an image capturing-duration ratio corresponds to a ratio of a total number of line-of-sight attentions received by a user in the group. In various embodiments, component 150 captures images of a group with the first virtual video camera and a second virtual camera in a determined sequence, wherein the first virtual video camera and the second virtual camera capture images of a plurality of groups in a descending order, according to the total number of line-of-sight attentions received by users in plurality of groups. In various embodiments, component 150 identifies a primary virtual video camera, wherein identifying the primary virtual video camera comprises: monitoring line-of-sight attention being received by each user in a group; and responsive to identifying a virtual video camera filming the one or more users receiving a majority of the line-of-sight attention based on the monitoring, labeling the virtual video camera as the primary virtual video camera.

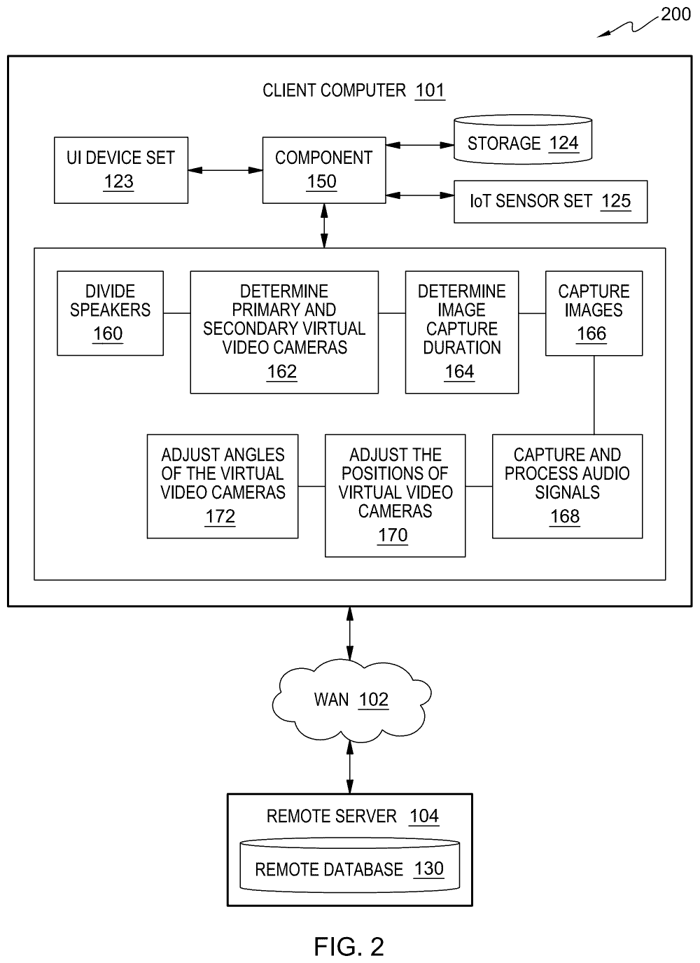

FIG. 2 is a functional block diagram illustrating a distributed data processing environment, generally designated 200, in accordance with one embodiment of the present invention. The term “distributed” as used in this specification describes a computer system that includes multiple, physically distinct devices that operate together as a single computer system. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes client computer 101, and remote server 104 interconnected via WAN 102.

In block 160, component 150 divides the users. In various embodiments, component 150 divides the users (e.g., speakers of a live event) within a virtual world into groups. In various embodiments, based on the positions of users, represented by virtual avatars, in a 3D virtual environment, component 150 clusters the users into one or more groups using a greedy algorithm. For example, if the distance between two speakers is less than or equal to a preset distance threshold, then the two speakers are clustered into one group.

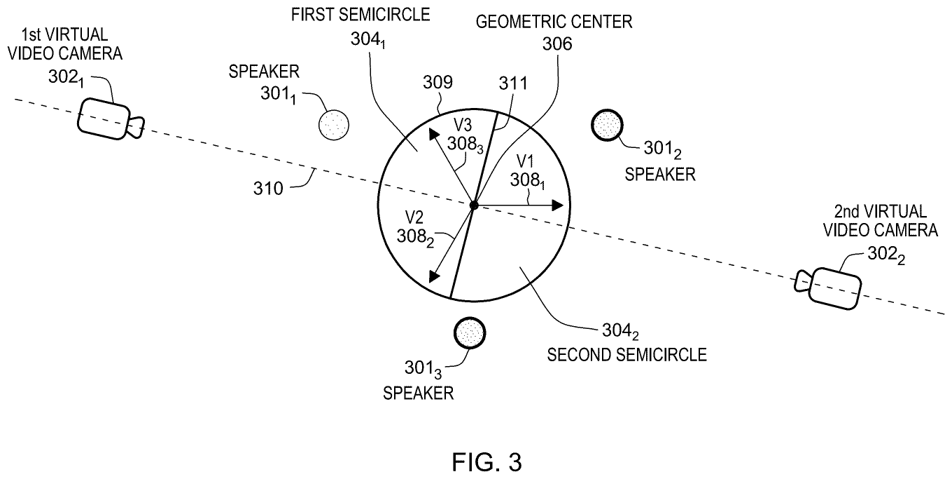

In block 162, component 150 determines the primary and secondary virtual video cameras. In various embodiments, component 150 determines the primary and secondary virtual video cameras and movement tracks in a group of users (i.e., group). In various embodiments, component 150 projects a head orientation (a three-dimensional vector) of each user(s) in the 3D virtual environment to an invisible two-dimensional unit vector on the virtual horizontal ground. In various embodiments, for the users clustered in a group, component 150 takes the geometric center of positions of each user in the group on the virtual horizontal ground as a center and creates an invisible circle with a radius greater than unit length. In various embodiments, component 150 projects the real-time head orientation (a three-dimensional vector) of each user (represented by a virtual avatar) to an invisible two-dimensional unit vector on the virtual horizontal ground, as further illustrated in FIG. 3. All unit vectors in the group can be translated into the circle, wherein the starting point of each unit vector coincides with the center of the circle.

In various embodiments, component 150 determines one or more semicircles that contain the most unit vectors in the circle and identifies one semicircle, from the one or more semicircles that contain the most unit vectors in the circle, as a first semicircle, and the other semicircle as a second semicircle. In various embodiments, a first virtual video camera is placed on a radius (as the movement track) that is perpendicular to the diameter of the first semicircle and passes through the center of the circle. In various embodiments, the image capturing direction of the first virtual video camera is towards the first semicircle, capturing as many of the faces of the speakers who correspond to the unit vectors in the first semicircle as possible, further illustrated in FIG. 3 below. In some embodiments, if the second semicircle contains unit vectors, then a second virtual video camera is placed on a radius (as the movement track) that is perpendicular to the diameter of the second semicircle and passes through the center of the circle to capture as many of the faces of the speakers who correspond to the unit vectors in the second semicircle. In various embodiments, if the users, whose faces are filmed by one virtual video camera (e.g., the first virtual video camera), receive more attention (calculated as the number of received lines-of-sight attentions) from listeners than the speakers whose faces are filmed by the other virtual video camera (e.g., the second virtual video camera), then the virtual video camera is labeled as the primary virtual video camera, and the other virtual camera(s) are labeled as secondary virtual video camera.

In block 164, component 150 determines image capture duration. In various embodiments, component 150 allocates the image capture duration of the users in a group (e.g., speakers) proportionally. In various embodiments, in a group, the image capturing-duration ratio of a primary virtual video camera to a secondary virtual video camera is T. A preset duration s (e.g., 0.2 sec) can be allocated to a secondary virtual video camera as initial image capturing duration. For any two groups, the image capturing-duration ratio corresponds to the ratio of the total number of line-of-sight attentions received by the respective speakers in the group. For example, suppose that the total number of line-of-sight attentions (also referred to as line-of-sight focus) received by Group A's speakers is m, and the total number of line-of-sight attentions received by Group B's speakers is n (m≥n; P=Round(m/n)). Then the initial shooting durations of Group A's primary and secondary virtual video cameras are T*s and s seconds, respectively, and the initial shooting durations of Group B's primary and secondary virtual video cameras are also T*s and s seconds, respectively. Thus, the final shooting durations of Group A's primary and secondary virtual video cameras are determined as P*T*s and P*s seconds, respectively, and the final shooting durations of Group B's primary and secondary virtual video cameras are determined as T*s and s seconds, respectively.

In block 166, component 150 captures images. In various embodiments, component 150 captures images of the group with virtual video cameras in a determined sequence, wherein the determined sequence may be calculated or predetermined. In various embodiments, in the process of image capturing a 2D video the image capturing devices are switched to virtual video cameras according to the following sequence, and the virtual video cameras record video according to the determined image capturing durations, wherein at any point in time, only one virtual video camera is filming. In some embodiments, one or more virtual video cameras are filming based on the determined image capturing durations and sequence. In various embodiments, the virtual video camera captures images (e.g., video) of the groups in a descending order, according to the total number of line-of-sight attentions received by the respective speakers of groups, wherein image capturing is performed by primary virtual video camera first followed by the secondary virtual video camera second. In various embodiments, if there is only one group, then component 150 alternately uses the primary and secondary virtual video cameras to image capture.

In block 168, component 150 captures and processes audio signals. In various embodiments, component 150 captures audio signals, via IoT sensor set 125 (e.g., microphones) and/or UI device set 123, of the users (e.g., speakers) in the current 3D virtual environment. In various embodiments, component 150 adjusts (e.g., attenuate) the audio volume of each user using existing audio processing techniques based on the location of the virtual video camera that is currently filming (as the current audio signal receiver) and the positions of users.

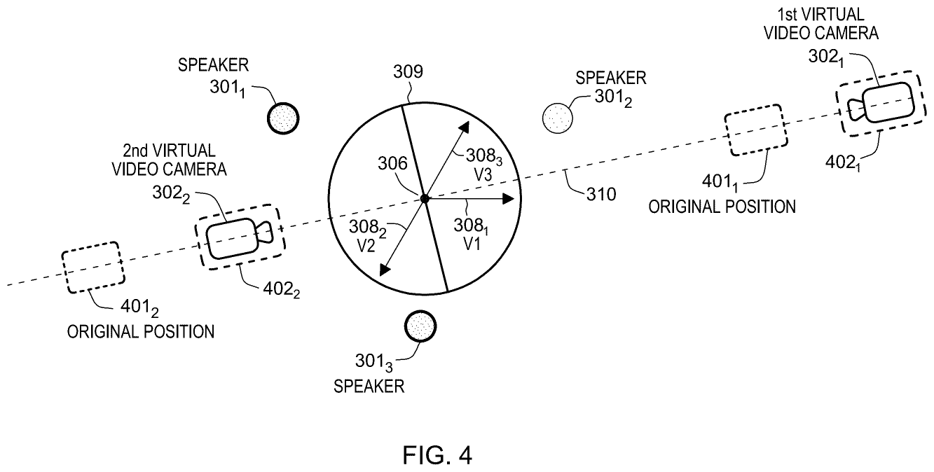

In block 170, component 150 adjusts the positions of the virtual video cameras. In various embodiments, component 150 adjusts the positions of the virtual video cameras based on the movement of the users (e.g., speakers) and/or attention the users are receiving. In various embodiments, component 150 dynamically increases or decreases the distance between the current image capturing virtual video camera and the center of a related circle based on the decrement or increment of the total number of line-of-sight attentions received by the speakers whose faces are being filmed by the virtual video camera. In various embodiments, the increment of the distance has a linear (or exponential) relationship to the increment of the total number of received line-of-sight attentions. In various embodiments, the range in which the virtual video camera moves along the movement track (a related radial direction) is either (i) gradually approaching the center of the generate circle encompassing the group based on the identified vectors or (ii) gradually moving away from the center of the generate circle encompassing the group based on the identified vectors. An example of the position adjustment of the virtual video cameras is further described in FIG. 4. In various embodiments, component 150 adjusts (e.g., moves) the virtual camera gradually towards the center of the circle when at least a portion of the users face moves out of the virtual video camera's field of view so that the distance between the camera and the center is a minimum distance. The minimum distance can be calculated based on previous positions of the virtual video camera and the center of the circle or be a predetermined distance from the center of the circle. In various embodiments, component 150 adjusts (e.g., moves) the virtual camera gradually away from the center of the circle when the audio volume of any speaker captured by that camera (as an audio signal receiver) is equal to or greater than a predetermined minimum volume so that the distance between the camera and the center of the circle is a maximum distance. The maximum distance can be calculated based on previous positions of the virtual video camera and the center of the circle or be a predetermined distance from the center of the circle.

In block 172, component 150 adjusts one or more angles of the virtual video cameras. In various embodiments, component 150 adjusts the image capturing angles of the one or more virtual video cameras. In various embodiments, the initial image capturing angle of a virtual video camera is horizontal, component 150 applies a vertical lift to the camera so that the camera can be level with the users face and/or head. Additionally, in various embodiments, in the process of changing the distance between the camera and the center of the circle, if the face of a targeted user (i.e., a user being filmed by the virtual video camera and/or receiving visual focus attention from the audience) is blocked by a virtual avatar so that the image capturing field of view is obscured, then component 150 can further adjust the vertical and/or horizontal direction of the virtual video camera so that the obstruction is avoided. In various embodiments, the virtual video cameras shoot with a minimum tilt angle in order to pass through the obstructing virtual avatars, wherein the minimum tilt angle is predetermined. In one embodiment, by raising the height of the camera in the vertical direction (e.g., after the camera is vertically elevated, the angle between its shooting direction and the virtual horizontal ground reaches the minimum tilt angle), the virtual avatar's facial outline and key facial points of the target person (e.g., the speaker) are fully captured within the camera's field of view without any obstruction from other virtual avatars. In other embodiments, component 150 can make the obstructing virtual avatars transparent or invisible.

FIG. 3 is a functional block diagram illustrating one embodiment of the present invention. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

For example, as depicted in FIG. 3, there is speaker 301₁ (i.e., a first speaker), speaker 301₂ (i.e., a second speaker), and speaker 301₃ (i.e., a third speaker) hereinafter collectively referred to as the speakers 301. In the depicted embodiment, component 150 identifies and labels unit vector 308₁, unit vector 308₂, and unit vector 308₃ (collectively referred to as unit vectors 308) within a group of users in which unit vectors 308 are translated into circle 309, wherein the starting point of each unit vector (e.g., unit vector 308₁, unit vector 308₂, and unit vector 308₃) coincides with the center 306 of circle 309. In this example, unit vector 308₁, unit vector 308₂, and unit vector 308₃ indicate the respective head orientations of the speakers 301, wherein unit vectors 308 are translated to create circle 309. In the depicted embodiment, component 150 determines the existence of semicircle 304₁ and semicircle 304₂, wherein component 150 identifies semicircle 304₁ as the first semicircle and semicircle 304₂ as the second semicircle because semicircle 304₁ contains the most unit vectors in circle 309 (e.g., unit vector 308₂ and unit vector 308₃) when compared to semicircle 304₂.

In the depicted embodiment, virtual video camera (first virtual camera) 302₁ is placed on radius 310 (as the movement track) that is perpendicular to the diameter 311 of the first semicircle (i.e., semicircle 304₁) and passes through the center 306 of the circle 309. The image capturing direction of first virtual camera 302₁ is towards semicircle 304₁ so that first virtual camera 302₁ captures as many of the faces of the speakers 301 who correspond to the unit vectors in semicircle 304₁ as possible. In the depicted embodiment, since the second semicircle (i.e., semicircle 304₂) contains unit vectors (i.e., unit vector 308₁) virtual video camera (second virtual camera) 302₂ is placed on radius 310 (as the movement track) that is perpendicular to the diameter 311 of the second semicircle (i.e., semicircle 304₂) and passes through the center 306 of the circle 309. The image capturing direction of second virtual camera 302₂ is towards semicircle 304₂ so that second virtual camera 302₂ captures as many of the faces of the speakers 301 who correspond to the unit vectors in semicircle 304₂.

In the depicted embodiment, if the speaker 301₂ and speaker 301₃ whose faces are filmed by virtual video camera 302₁ receive more attention from listeners than speaker 301₁ whose face is being filmed by virtual video camera 302₂ then virtual video camera 302₁ will be labeled as the primary virtual video camera and virtual video camera 302₂ will be labeled as the secondary virtual video camera. For example, speaker 301₁ is filmed by the second virtual video camera 302₂ and speaker 301₂ and speaker 301₃ are filmed by the first virtual video camera 302₁. Suppose that there are ten listeners viewing speakers 301 which is detected and monitored using a line of sight sensor respectively. In this example, based on the detected and monitored lines of sight if the number of lines-of-sights focused speaker 301₁ is greater than the number of lines-of-sights focused speaker 301₂ and speaker 301₃ then second virtual video camera 302₂ is identified as the primary virtual video camera, and first virtual video camera 302₁ is identified as the secondary virtual video camera.

FIG. 4 is a functional block diagram illustrating one embodiment of the present invention. FIG. 4 provides only an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, component 150 identifies and labels unit vector 308₁, unit vector 308₂, and unit vector 308₃ (collectively referred to as unit vectors 308) within a group of users in which unit vectors 308 are translated into circle 309, wherein the starting point of each unit vector (e.g., unit vector 308₁, unit vector 308₂, and unit vector 308₃) coincides with the center 306 of circle 309. In the depicted embodiment, first virtual video camera 302₁ is filming the faces of speaker 301₁ and speaker 301₃ and second virtual video camera 302₂ is filming the face of speaker 301₂. In the depicted embodiment, as the number of line-of-sight attentions received by speaker 301₂ increases and the number of line-of-sight attentions received speaker 301₁ and speaker 301₃ decreases component 150 dynamically adjusts the position of first virtual video camera 302₁ and second virtual video camera 302₂. In the depicted embodiment, responsive to the increase in attention being received by speaker 301₂ from the audience, second virtual video camera 302₂ is moved, along radius 310, closer to center 306 of circle 309 from original position 401₂ to new position 402₂. Similarly, in the depicted embodiment, responsive to speaker 301₁ and speaker 301₃ losing attention from the audience, first virtual video camera 302₁ is moved, along radius 310, further from center 306 of circle 309 from original position 401₁ to new position 402₁.

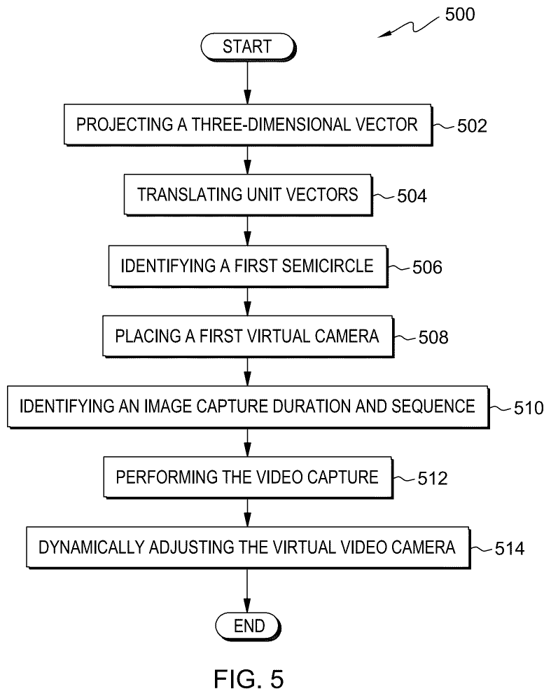

FIG. 5 illustrates operational steps of component 150, generally designated 500, in communication with client computer 101, remote server 104, private cloud 106, EUD 103, client computer 101, and/or public cloud 105, within distributed data processing environment 100, for selectively rendering physical objects into a virtual environment, the computer-implemented method, in accordance with an embodiment of the present invention. FIG. 5 provides an illustration of one implementation and does not imply any limitations with regard to the environments in which different embodiments may be implemented. Many modifications to the depicted environment may be made by those skilled in the art without departing from the scope of the invention as recited by the claims.

In block 502, component 150 projects a three-dimensional vector. In various embodiments, component 150 determines the primary and secondary virtual video cameras. In various embodiments, component 150 determines the primary and secondary virtual video cameras and movement tracks in a group of users (i.e., group). In various embodiments, component 150 projects a head orientation (a three-dimensional vector) of each user(s) (e.g., the head of an avatar associated with the user) in the 3D virtual environment to an invisible two-dimensional unit vector on the virtual horizontal ground. In various embodiments, the head orientation (a three-dimensional vector) is projected onto the virtual horizontal ground, forming a two-dimensional vector. In some embodiments, both the three-dimensional and two-dimensional vectors are invisible to all users and only visible to component 150. In various embodiments, for the users clustered in a group, component 150 takes the geometric center of positions of each user in the group on the virtual horizontal ground as a center and creates an invisible circle with a radius greater than unit length. In various embodiments, component 150 projects the real-time head orientation (a three-dimensional vector) of each user (represented by a virtual avatar) to an invisible two-dimensional unit vector on the virtual horizontal ground.

In block 504, component 150 translates the unit vectors. In various embodiments, the unit vectors in the group are translated into a circle, wherein the starting point of each unit vector coincides with the center of the circle. In various embodiments, the projected two-dimensional unit vectors are located on the virtual horizontal ground. In some embodiments, each unit vector is translated within the same group on the virtual horizontal ground so that their starting points coincide with the corresponding center points. Translating a two-dimensional vector on a plane refers to moving the vector to another position while keeping its direction and magnitude unchanged.

In block 506, component 150 identifies a first semicircle. In various embodiments, component 150 determines one or more semicircles that contain the most unit vectors in the circle and identifies one semicircle, from the one or more semicircles that contain the most unit vectors in the circle, as a first semicircle, and the other semicircle as a second semicircle.

In block 508, component 150 places a first virtual camera. In various embodiments, component 150 places a first virtual camera to film one or more users in the circle. In various embodiments, a first virtual video camera is placed on a radius (as the movement track) that is perpendicular to the diameter of the first semicircle and passes through the center of the circle. In various embodiments, the image capturing direction of the first virtual video camera is towards the first semicircle, capturing as many of the faces of the speakers who correspond to the unit vectors in the first semicircle as possible. In some embodiments, if the second semicircle contains unit vectors, then a second virtual video camera is placed on a radius (as the movement track) that is perpendicular to the diameter of the second semicircle and passes through the center of the circle to capture as many of the faces of the speakers who correspond to the unit vectors in the second semicircle. In various embodiments, if the users, whose faces are filmed by one virtual video camera (e.g., the first virtual video camera), receive more attention (calculated as the number of received lines-of-sight attentions) from listeners than the speakers whose faces are filmed by the other virtual video camera (e.g., the second virtual video camera), then the virtual video camera is labeled as the primary virtual video camera, and the other virtual camera(s) are labeled as secondary virtual video camera.

In block 510, component 150 identifies a video capture duration and sequence. In various embodiments, component 150 determines image capture duration. In various embodiments, component 150 allocates the image capture duration of the users in a group (e.g., speakers) proportionally. In various embodiments, in a group, the image capturing-duration ratio of a primary virtual video camera to a secondary virtual video camera is T. A preset duration s (e.g., 0.2 sec) can be allocated to a secondary virtual video camera as initial image capturing duration. For any two groups, their image capturing-duration ratio corresponds to the ratio of the total number of line-of-sight attentions received by their respective speakers. For example, suppose that the total number of line-of-sight attentions (also referred to as line-of-sight focus) received by Group A's speakers is m, and the total number of line-of-sight attentions received by Group B's speakers is n (m≥n; P=Round(m/n)). Then the initial shooting durations of Group A's primary and secondary virtual video cameras are T*s and s seconds, respectively, and the initial shooting durations of Group B's primary and secondary virtual video cameras are also T*s and s seconds, respectively. Thus, the final shooting durations of Group A's primary and secondary virtual video cameras are determined as P*T*s and P*s seconds, respectively, and the final shooting durations of Group B's primary and secondary virtual video cameras are determined as T*s and s seconds, respectively.

In block 512, component 150 performs image capture based on the identified video capturing duration and sequence. In various embodiments, component 150 utilizes virtual video cameras to perform image capture based on the identified video capturing duration and sequence. In various embodiments, component 150 captures images of the group with virtual video cameras in a determined sequence, wherein the determined sequence may be calculated or predetermined. In various embodiments, in the process of image capturing a 2D video the image capturing devices are switched to virtual video cameras according to the following sequence, and the virtual video cameras record video according to the determined image capturing durations, wherein at any point in time, only one virtual video camera is filming. In some embodiments, one or more virtual video cameras are filming based on the determined image capturing durations and sequence. In various embodiments, the virtual video camera captures images (e.g., video) of the groups in a descending order, according to the total number of line-of-sight attentions received by the respective speakers of groups, wherein image capturing is performed by primary virtual video camera first followed by the secondary virtual video camera second. In various embodiments, if there is only one group, then component 150 alternately uses the primary and secondary virtual video cameras to image capture.

In block 514, component 150 dynamically adjusts the virtual video camera. In various embodiments, component 150 adjusts the positions of the virtual video cameras based on the movement of the users (e.g., speakers) and/or attention the users are receiving. In various embodiments, component 150 dynamically increases or decreases the distance between the current image capturing virtual video camera and the center of a related circle based on the decrement or increment of the total number of line-of-sight attentions received by the speakers whose faces are being filmed by the virtual video camera. In various embodiments, the increment of the distance has a linear (or exponential) relationship to the increment of the total number of received line-of-sight attentions. In various embodiments, the range in which the virtual video camera moves along the movement track (a related radial direction) is either (i) gradually approaching the center of the generate circle encompassing the group based on the identified vectors or (ii) gradually moving away from the center of the generate circle encompassing the group based on the identified vectors. In various embodiments, component 150 adjusts (e.g., moves) the virtual camera gradually towards the center of the circle when at least a portion of the users face moves out of the virtual video camera's field of view so that the distance between the camera and the center is a minimum distance. The minimum distance can be calculated based on previous positions of the virtual video camera and the center of the circle or be a predetermined distance from the center of the circle. In various embodiments, component 150 adjusts (e.g., moves) the virtual camera gradually away from the center of the circle when the audio volume of any speaker captured by that camera (as an audio signal receiver) is equal to or greater than a predetermined minimum volume so that the distance between the camera and the center of the circle is a maximum distance. The maximum distance can be calculated based on previous positions of the virtual video camera and the center of the circle or be a predetermined distance from the center of the circle.

In various embodiments, component 150 adjusts one or more angles of the virtual video cameras. In various embodiments, component 150 adjusts the image capturing angles of the one or more virtual video cameras. In various embodiments, the initial image capturing angle of a virtual video camera is horizontal, component 150 applies a vertical lift to the camera so that the camera can be level with the users face and/or head. Additionally, in various embodiments, in the process of changing the distance between the camera and the center of the circle, if the face of a targeted user (i.e., a user being filmed by the virtual video camera and/or receiving visual focus attention from the audience) is blocked by a virtual avatar so that the image capturing field of view is obscured, then component 150 can further adjust the vertical and/or horizontal direction of the virtual video camera so that the obstruction is avoided. In various embodiments, the virtual video cameras shoot with a minimum tilt angle in order to pass through the obstructing virtual avatars. The minimum tilt angle is predetermined.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
projecting a three-dimensional vector of one or more users in a three-dimensional (3D) virtual world environment to one or more invisible two-dimensional (2D) unit vector on a virtual horizontal ground;
translating the one or more unit vectors into a circle centered geometrically at positions related to the one or more users, wherein a starting point of each of the one or more unit vector coincides with a center of the circle;
identifying a first semicircle of the circle;
placing a first virtual video camera on a radius perpendicular to a diameter of the first semicircle that passes through the center of the circle;
identifying an image capturing duration and image capturing sequence based on a total number of line-of-sight attentions received by the one or more users; and
adjusting a distance between the first virtual video camera and the center of the circle dynamically, according to the total number of line-of-sight attentions received by the one or more users.

2. The computer-implemented method of claim 1 further comprising:
dividing the one or more users within the 3D virtual world environment into groups, wherein dividing the one or more users within the 3D virtual world environment into the groups comprises:
clustering the one or more users into one or more groups based on positions of a virtual avatar associated with each user in the virtual world environment.

3. The computer-implemented method of claim 1, wherein identifying the first semicircle comprises:
identifying the first semicircle based on an amount of unit vectors present in the first semicircle, wherein the first semicircle comprises at least one or more unit vector than a second semicircle.

4. The computer-implemented method of claim 1, wherein identifying the image capture duration comprises:
allocating the image capture duration of the one or more users in a group proportionally.

5. The computer-implemented method of claim 4, wherein an image capturing-duration ratio corresponds to a ratio of a total number of line-of-sight attentions received by a user in the group.

6. The computer-implemented method of claim 1, further comprising:
capturing images of a group with the first virtual video camera and a second virtual camera in a determined sequence, wherein the first virtual video camera and the second virtual camera capture images of a plurality of groups in a descending order, according to the total number of line-of-sight attentions received by users in plurality of groups.

7. The computer-implemented method of claim 1 further comprising:
identifying a primary virtual video camera, wherein identifying the primary virtual video camera comprises:
monitoring line-of-sight attention being received by each user in a group; and
responsive to identifying a virtual video camera filming the one or more users receiving a majority of the line-of-sight attention based on the monitoring, labeling the virtual video camera as the primary virtual video camera.

8. A computer system comprising:
one or more computer processors;
one or more computer readable storage devices;
program instructions stored on the one or more computer readable storage devices for execution by at least one of the one or more computer processors, the stored program instructions comprising:
program instructions to project a three-dimensional vector of one or more users in a three-dimensional (3D) virtual world environment to one or more invisible two-dimensional (2D) unit vector on a virtual horizontal ground;
program instructions to translate the one or more unit vectors into a circle centered geometrically at positions related to the one or more users, wherein a starting point of each of the one or more unit vector coincides with a center of the circle;
program instructions to identify a first semicircle of the circle;
program instructions to place a first virtual video camera on a radius perpendicular to a diameter of the first semicircle that passes through the center of the circle;
program instructions to identify an image capturing duration and image capturing sequence based on a total number of line-of-sight attentions received by the one or more users; and
program instructions to adjust a distance between the first virtual video camera and the center of the circle dynamically, according to the total number of line-of-sight attentions received by the one or more users.

9. The computer-implemented method of claim 1 further comprising:
program instructions to divide the one or more users within the 3D virtual world environment into groups, wherein dividing the one or more users within the 3D virtual world environment into the groups comprises:
program instructions to cluster the one or more users into one or more groups based on positions of a virtual avatar associated with each user in the virtual world environment.

10. The computer system of claim 8, wherein identifying the first semicircle comprises:
program instructions to identify the first semicircle based on an amount of unit vectors present in the first semicircle, wherein the first semicircle comprises at least one or more unit vector than a second semicircle.

11. The computer system of claim 8, wherein identifying the image capture duration comprises:
program instructions to allocate the image capture duration of the one or more users in a group proportionally.

12. The computer system of claim 11, wherein an image capturing-duration ratio corresponds to a ratio of a total number of line-of-sight attentions received by a user in the group.

13. The computer system of claim 8, further comprising:
capturing images of a group with the first virtual video camera and a second virtual camera in a determined sequence, wherein the first virtual video camera and the second virtual camera capture images of a plurality of groups in a descending order, according to the total number of line-of-sight attentions received by users in plurality of groups.

14. The computer system of claim 8, further comprising:
identifying a primary virtual video camera, wherein identifying the primary virtual video camera comprises:
monitoring line-of-sight attention being received by each user in a group; and
responsive to identifying a virtual video camera filming the one or more users receiving a majority of the line-of-sight attention based on the monitoring, labeling the virtual video camera as the primary virtual video camera.

15. A computer program product comprising:
one or more computer readable storage devices and program instructions stored on the one or more computer readable storage devices, the stored program instructions comprising:
program instructions to project a three-dimensional vector of one or more users in a three-dimensional (3D) virtual world environment to one or more invisible two-dimensional (2D) unit vector on a virtual horizontal ground;
program instructions to translate the one or more unit vectors into a circle centered geometrically at positions related to the one or more users, wherein a starting point of each of the one or more unit vector coincides with a center of the circle;
program instructions to identify a first semicircle of the circle;
program instructions to place a first virtual video camera on a radius perpendicular to a diameter of the first semicircle that passes through the center of the circle;
program instructions to identify an image capturing duration and image capturing sequence based on a total number of line-of-sight attentions received by the one or more users; and
program instructions to adjust a distance between the first virtual video camera and the center of the circle dynamically, according to the total number of line-of-sight attentions received by the one or more users.

16. The computer program product of claim 15 further comprising:
program instructions to divide the one or more users within the 3D virtual world environment into groups, wherein dividing the one or more users within the 3D virtual world environment into the groups comprises:
program instructions to cluster the one or more users into one or more groups based on positions of a virtual avatar associated with each user in the virtual world environment.

17. The computer program product of claim 15, wherein identifying the first semicircle comprises:
program instructions to identify the first semicircle based on an amount of unit vectors present in the first semicircle, wherein the first semicircle comprises at least one or more unit vector than a second semicircle.

18. The computer program product of claim 15, wherein identifying the image capture duration comprises:
program instructions to allocate the image capture duration of the one or more users in a group proportionally, wherein an image capturing-duration ratio corresponds to a ratio of a total number of line-of-sight attentions received by a user in the group.

19. The computer program product of claim 15, further comprising:
capturing images of a group with the first virtual video camera and a second virtual camera in a determined sequence, wherein the first virtual video camera and the second virtual camera capture images of a plurality of groups in a descending order, according to the total number of line-of-sight attentions received by users in plurality of groups.

20. The computer program product of claim 15, further comprising:
identifying a primary virtual video camera, wherein identifying the primary virtual video camera comprises:
monitoring line-of-sight attention being received by each user in a group; and
responsive to identifying a virtual video camera filming the one or more users receiving a majority of the line-of-sight attention based on the monitoring, labeling the virtual video camera as the primary virtual video camera.
